(19) United States
(12) Patent Application Publication
(10) Pub. No.: US 2018/0031790 A1
(43) Pub. Date: Feb. 1, 2018

(54) OPTICAL COUPING MODULE AND OPTICAL COMMUNICATION APPARATUS USING THE SAME

(71) Applicant: TRUELIGHT CORPORATION, HSINCHU (TW)

(72) Inventors: CHENG-TA CHEN, TAICHUNG CITY (TW); CHIA-HAO HSIEH, HSINCHU CITY (TW); CHIA-CHING CHANG CHIEN, KAOHSIUNG CITY (TW)

(21) Appl. No.: 15/473,326

(22) Filed: Mar. 29, 2017

(30) Foreign Application Priority Data
Jul. 27, 2016 (TW) 105123743

(51) Int. Cl. G02B 6/42; G02B 6/32

(52) U.S. Cl. CPC G02B 6/4286; G02B 6/4214; G02B 6/4206; G02B 6/32

(57) ABSTRACT

An optical coupling structure and an optical communication apparatus using the same are provided. The optical coupling structure includes a light incident portion, a light splitting portion, a first light emitting portion, and a second light emitting portion. An initial optical signal entering the optical coupling structure through the light incident portion is divided into a first beam and second beam by the light splitting portion, which includes a first reflective surface and a second reflective surface, and the slopes of the first and second reflective surfaces are both positive or both negative. The first beam is converted by the first light emitting portion into a first optical signal for transmitting to an optical transmission unit. The second beam is converted by the second light emitting portion into a second optical signal for transmitting to a photodetector.

### BACKGROUND OF THE INVENTION

### 1. Field of the Invention

The instant disclosure relates to an optical coupling structure and an optical communication apparatus using the same; in particular, to an optical coupling structure and an optical communication apparatus capable of providing feedback of optical signals.

### 2. Description of Related Art

A conventional optical communication apparatus usually includes a light output device for outputting optical signal, an optical fiber for receiving and transmitting the optical signal, and an optical assembly for transmitting the optical signal to the optical fiber. To be more specific, the light output device, such as a laser, outputs the optical signal to the optical assembly so that the optical signal can be transmitted to the optical fiber through the optical assembly.

In addition, in order to maintain the output power stability and detect the deterioration of the light output device during normal lifetime under the operation conditions of normal operation temperature, the light output power of the light output device has to be monitored. Accordingly, the optical assembly needs to be improved in structure so that a portion of the optical signal can be guided to a monitor photodiode (MPD) for monitoring the light output power.

### SUMMARY OF THE INVENTION

In order to achieve the aforementioned objects, an optical coupling structure and an optical communication apparatus using the same are provided in the instant embodiment. The coupling structure includes a light splitting portion disposed on an optical axis of the lighting element to guide the optical signal outputted by the lighting element respectively to an optical transmission unit and a photodetector.

An optical coupling structure provided in one of the embodiments of the instant disclosure includes a light incident portion, a light splitting portion, a first light emitting portion, and a second light emitting portion. The light incident portion is arranged for receiving an initial optical signal emitted by a lighting element, and the initial optical signal is converted into a parallel beam by passing through the light incident portion. The light splitting portion is disposed on an optical path of the parallel beam. The light splitting portion includes a first reflective surface, a second reflective surface, and a connecting surface connected between the first reflective surface and the second reflective surface so that a height difference exists between the first reflective surface and the second reflective surface. The parallel beam is divided into a first beam and a second beam through the first reflective surface and the second reflective surface, and the slopes of the first reflective surface and the second reflective surface are both positive or both negative. The first light emitting portion is disposed on an optical path of the first beam, in which the first beam is converted into a first optical signal through the first light emitting portion for transmitting to an optical transmission unit. The second light emitting portion is disposed on an optical path of the second beam, in which the second beam is converted into a second optical signal through the second light emitting portion for transmitting to a photodetector.

An optical communication apparatus is provided in the embodiment of the instant disclosure. The optical communication apparatus includes a lighting element for emitting an initial light signal, an optical transmission unit, a photodetector, and an optical coupling structure. The photodetector and the optical transmission unit are arranged at the same side of the lighting element. The optical coupling structure includes a light incident portion for receiving the initial optical signal, a light splitting portion, a first light emitting portion, and a second light emitting portion. The initial optical signal is converted into a parallel beam by passing through the light incident portion. The light splitting portion is disposed on an optical path of the parallel beam. The light splitting portion includes a first reflective surface, a second reflective surface, and a connecting surface connected between the first reflective surface and the second reflective surface so that a height difference exists between the first reflective surface and the second reflective surface. The parallel beam is reflected by the first reflective surface and the second reflective surface and divided into a first beam and a second beam, and slopes of the first reflective surface and the second reflective surface are both positive or both negative. The first light emitting portion is disposed on an optical path of the first beam, in which the first beam is converted into a first optical signal through the first light emitting portion for transmitting to an optical transmission unit. The second light emitting portion is disposed on an optical path of the second beam, in which the second beam is converted into a second optical signal for transmitting to a photodetector through the second light emitting portion.

To sum up, in the instant disclosure, the initial optical signal outputted by the lighting element enters the optical coupling structure, projects on two different reflective surfaces of the light splitting portion, and then is divided into a first beam and a second beam with different emission directions. The first beam and the second beam are respectively transmitted to the optical transmission unit and the photodetector.

Accordingly, the photodetector can receive the optical signal through the optical coupling structure to monitor the light output power of the lighting element. Once the deterioration of the lighting element or other problems occur, the lighting element can be repaired or replaced to maintain the stability of the optical communication.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a cross-sectional view of a localized optical communication apparatus according to an embodiment of the instant disclosure;

FIG. 1A shows an enlarged view of the region A shown in FIG. 1; and

FIG. 2 shows a cross-sectional view of a localized optical coupling structure according to another embodiment of the instant disclosure.

### DETAILED DESCRIPTION OF THE PREFERRED EMBODIMENTS

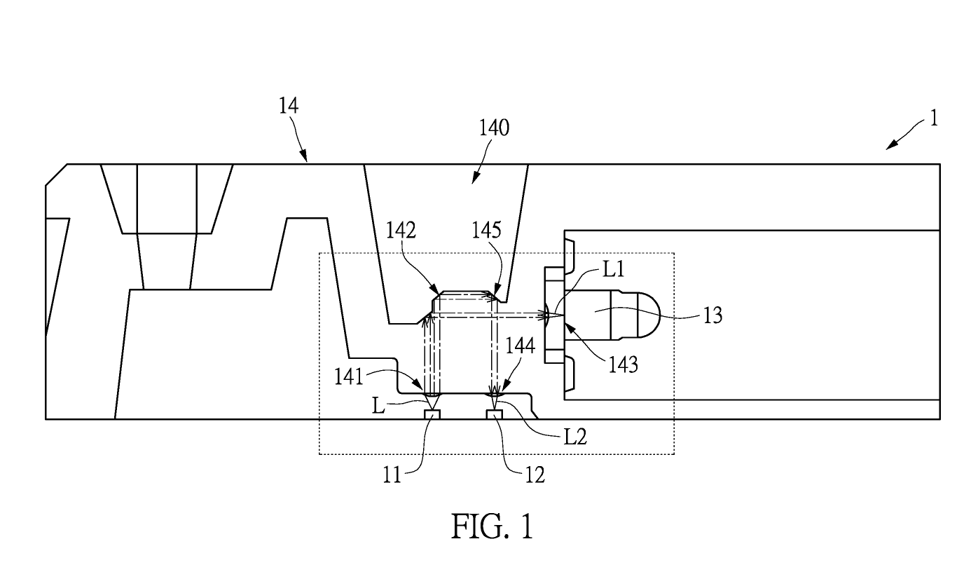

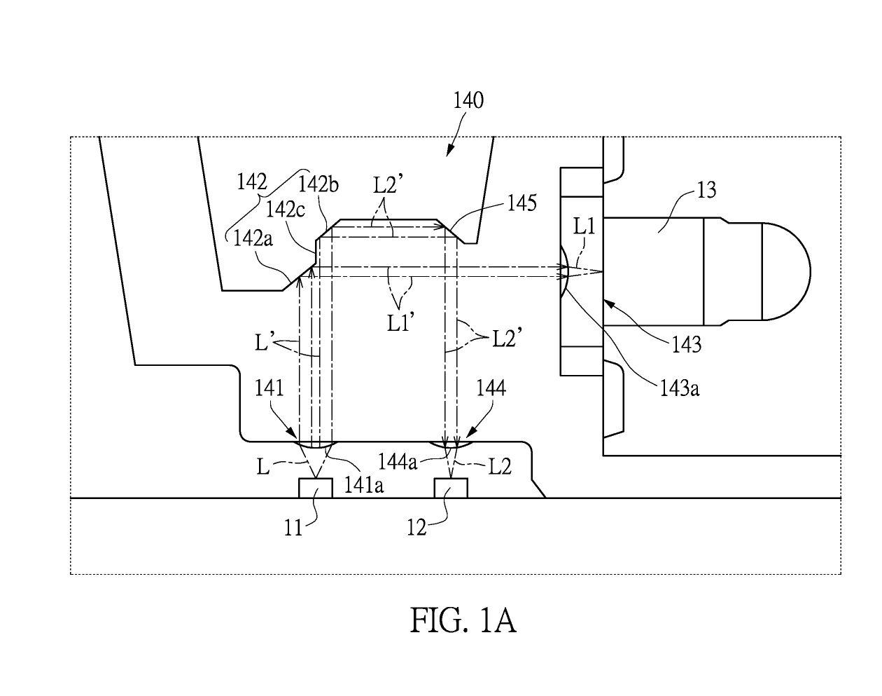

FIG. 1 shows a cross-sectional view of a localized optical communication apparatus according to an embodiment of the instant disclosure. The optical communication apparatus 1 includes a lighting element 11, a photodetector 12, an optical transmission unit 13, and an optical coupling structure 14. In the instant disclosure, an initial optical signal L outputted by the lighting element 11 can be converted into a first optical signal L1 and a second optical signal L2 through the optical coupling structure 14, and the first optical signal L1 and the second optical signal L2 are respectively transmitted to the optical transmission unit 13 and to the photodetector 12. The details are described as follows.

The lighting element 11 converts an electrical signal into the corresponding initial optical signal L and then transmits the initial optical signal L to the optical coupling structure 14. The lighting element 11 can be a laser or other light source. In the instant embodiment, the lighting element 11 is a vertical cavity surface emitting laser (VCSEL). In addition, the initial optical signal L outputted by the lighting element 11 can have a wavelength ranging from 850 nm to 980 nm.

The optical transmission unit 13 is positioned at one side of the optical coupling structure 14 to receive the first optical signal L1, which is transmitted by the optical coupling structure 14. Thereafter, the first optical signal L1 can be transmitted to a photo receiver (not shown in FIG. 1) through the optical transmission unit 13. In the embodiment of the instant disclosure, the optical transmission unit 13 can be an optical fiber.

The photodetector 12 positioned at another side of the optical coupling structure 14 receives the second optical signal L2 transmitted by the optical coupling structure 14 to detect the intensity and stability of the initial optical signal L. In one embodiment, the photodetector 12 can be a photodiode, and the lighting element 11 and the photodetector 12 are mounted on the same circuit board (not shown). The photodetector 12 can convert the received second optical signal L2 into a current signal and then provide a feedback to a control unit (not shown), which is electrically connected to the lighting element 11. The control unit monitors and adjusts the light output power of the lighting element 11 according to the current signal transmitted by the photodetector 12. In the instant embodiment, the optical transmission unit 13 and the photodetector 12 are located at the same side of the lighting element 11.

In the embodiment of the instant disclosure, the optical coupling structure 14 includes a light incident portion 141, a light splitting portion 142, a first light emitting portion 143, and a second light emitting portion 144.

Please refer to FIG. 1A, which shows an enlarged view of the region A of the optical communication apparatus shown in FIG. 1. In the instant embodiment, the light incident portion 141 is located at a position corresponding to the position of the lighting element 11 to receive and convert the initial optical signal L to a parallel beam L′. The light incident portion 141 of the optical coupling structure 14 includes a collimating lens 141a for converting the initial optical signal L into the parallel beam L′. The collimating lens 141a can be a micro-lens unit for converting a divergent beam into a parallel beam.

The light splitting portion 142 disposed on an optical path of the parallel beam L′ includes a first reflective surface 142a and a second reflective surface 142b for dividing the parallel beam L′ into a first beam L1′ and a second beam L2′ with different emission directions. To be more specific, the parallel beam L′ projects on an interface between the first reflective surface 142a and the second reflective surface 142b. One portion of the parallel beam L′ reflected by the first reflective surface 142a forms the first beam L1′, which finally emits out of the optical coupling structure 14 through the first light emitting portion 143. The other portion of the parallel beam L′ reflected by the second reflective surface 142b forms the second beam L2′, which finally emits out of the optical coupling structure 14 through the second light emitting portion 144.

An extending direction of the first reflective surface 142a and an optical axis of the collimating lens 141a form a first acute angle θ1, and an extending direction of the second reflective surface 142b and the optical axis of the collimating lens 141a form a second acute angle θ2. The first acute angle θ1 can be equal to or less than the second acute angle θ2.

The first light emitting portion 143 receives the first beam L1′ reflected by the first reflective surface 142a, and converts the first beam L1′ into the first optical signal L1 for inputting to the optical transmission unit 13. The second light emitting portion 144 receives the second beam L2′ reflected by the second reflective surface 142b, and converts the second beam L2′ into the second optical signal L2 for inputting to the photodetector 12.

The positions of the first and second light emitting portions 143, 144 respectively correspond to the position of the optical transmission unit 13 and the position of the photodetector 12. In the embodiment of the instant disclosure, since the lighting element 11 and the photodetector 12 are disposed on the same circuit board, the light incident portion 141 and the second light emitting portion 144 are located at the same side of the optical coupling structure 14. Furthermore, the first light emitting portion 143 and the light incident portion 141 are respectively located at two adjacent sides of the optical coupling structure 14.

In the instant embodiment, the first light emitting portion 143 includes a first optical lens 143a for receiving the first beam L1′, and the second light emitting portion 144 includes a second optical lens 144a for receiving the second beam L2′. The first and second optical lenses 143a, 144a can be convex lenses or Fresnel lenses. The first optical lens 143a receives and converges the first beam L1′ to output the first optical signal L1. The second optical lens 144a receives and converges the second beam L2′ to output the second optical signal L2. In other words, the first beam L1′ can be converged to form the first optical signal L1 by the first optical lens 143a, and the second beam L2′ can be converged by the second optical lens 144a to form the second optical signal L2.

In the embodiment of the instant disclosure, the numbers of the collimating lens 141a, the first optical lens 143a, and the second optical lens 144a can be one or more, which depends on the number of the lighting elements 11, the optical transmission units 13, and the photodetectors 12.

Please refer to FIG. 1A. The light splitting portion 142 further includes a connecting surface 142c connected between the first reflective surface 142a and the second reflective surface 142b so that a height difference exists between the first and second reflective surfaces 142a, 142b. That is, the light splitting portion 142 includes a step difference structure.

Specifically, an extending direction of the connecting surface 142c is substantially parallel to the optical axis of the collimating lens 141a. The parallel beam L′ projects on the light splitting portion 142 in a direction parallel to the connecting surface 142c so as to be divided into the first beam L1′ and the second beam L2′. In the instant embodiment, the first acute angle θ1 can be equal to the second acute angle θ2. That is, the first reflective surface 142a is parallel to the second reflective surface 142b.

Moreover, the slopes of the first and second reflective surfaces 142a, 142b can be both positive or both negative. In the embodiment of the instant disclosure, since the optical transmission unit 13 and the photodetector 12 are both positioned at the right-side of the lighting element 11, the slopes of the first and second reflective surfaces 142a, 142b are both positive.

Please refer to FIG. 1 and FIG. 1A. In the instant embodiment, the optical coupling structure 14 includes a recess portion 140 located at the side opposite to the side at which the light incident portion 141 is located. The first reflective surface 142a, the second reflective surface 142b and the connecting surface 142c are disposed on an inner wall of the recess portion 140. That is, the first reflective surface 142a, the second reflective surface 142b and the connecting surface 142c are parts of the interface between two different media (i.e., the optical coupling structure 14 and air). In one embodiment, the first reflective surface 142a and the second reflective surface 142b can be coated with a totally reflective film or a partially reflective film, which is not limited in the instant disclosure. The first acute angle θ1 and the second acute angle θ2 can be total reflection angles of the optical coupling structure 14 or not, designed according to the material of the optical coupling structure 14 or the materials of the reflective films coated on the first reflective surface 142a or the second reflective surface 142b.

Upon the condition that both the first acute angle θ1 and the second acute angle θ2 are total reflection angles, the refraction of the parallel beam L′ projecting on the first and second reflective surfaces 142a, 142b from the optical coupling structure 14 to air would not occur. On the contrary, upon the condition that neither the first acute angle θ1 nor the second acute angles θ2 is a total reflection angle, a portion of the parallel beam L′ projecting on the first and second reflective surfaces 142a, 142b may be refracted to air.

Please refer to FIG. 1A. Furthermore, the optical coupling structure 14 further includes an inclined reflective surface 145. The inclined reflective surface 145 and the light splitting portion 142 are formed on the inner wall of the recess portion 140. The inclined reflective surface 145 is arranged at a position corresponding to the position of the second light emitting portion 144. The inclined reflective surface 145 is arranged on an optical path of the second beam L2′, facing to the second reflective surface 142b so that the second beam L2′ can be guided by the inclined reflective surface 145 to the second optical lens 144a.

The second reflective surface 142b and the inclined reflective surface 145 incline toward each other. That is, if the second reflective surface 142b has a positive slope, the inclined reflective surface 145 has negative slope. On the contrary, if the second reflective surface 142b has a negative slope, the inclined reflective surface 145 has a positive slope. The inclined reflective surface 145 is spaced apart from an optical path of the first beam L1′. Accordingly, the lowest end of the inclined reflective surface 145 is located at a higher level than the highest end of the first reflective surface 142a. Preferably, a horizontal extending plane where the lowest end of the inclined reflective surface 145 is located intersects the connecting surface 142c to ensure that the inclined reflective surface 145 can reflect the second beam L2′ and will not block the first beam L1′.

In one embodiment, the inclined reflective surface 145 and the light splitting portion 142 are commonly formed at the bottom of the recess portion 140, and the inclined reflective surface 145 is a total reflection surface. In another embodiment, a mirror coating or a light reflective sheet can be disposed on the first reflective surface 142a, the second reflective surface 142b and the inclined reflective surface 145. As long as the first beam L1′ and the second beam L2′ can be respectively guided to the first light emitting portion 143 and the second light emitting portion 144, the reflective materials for forming the first reflective surface 142a, the second reflective surface 142b and the inclined reflective surface 145 are not limited in the instant disclosure.

In the optical communication apparatus 1 of the instant embodiment, the lighting element 11 emits the initial optical signal L to the optical coupling structure 14, and the initial optical signal L is converted into the parallel beam L′ through the collimating lens 141a. The parallel beam L′ is in alignment with an extending direction of the connecting surface 142c and projects on the first and second reflective surfaces 142a, 142b. Thereafter, the parallel beam L′ is divided into the first beam L1′ and the second beam L2′. The first beam L1′ is converged by the first optical lens 143a of the first light emitting portion 143 to form the first optical signal L1 for transmitting to the optical transmission unit 13. Additionally, the second beam L2′ is reflected by the inclined reflective surface 145 to project the second light emitting portion 144, and then the second beam L2′ is converged by the second optical lens 144a to form the second optical signal L2 for transmitting to the photodetector 12. Accordingly, the photodetector 12 converts the second optical signal L2 into the current signal and provides a feedback to the control unit so that the control unit can monitor and adjust the light output power of the lighting element 11 according to the feedback (the received current signal). As such, by receiving the second optical signal L2, the photodetector 12 can detect the intensity and stability of the initial optical signal L.

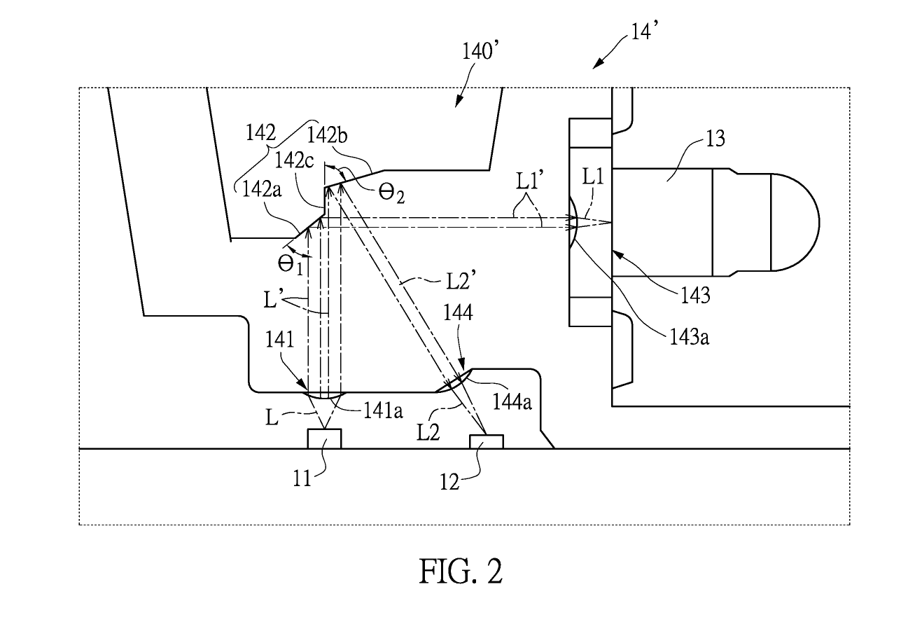

Please refer to FIG. 2, which shows a cross-sectional view of an optical coupling structure according to another embodiment of the instant disclosure. The same reference numerals are given to the same components or to components corresponding to those in FIG. 1A, and descriptions of the common portions are omitted.

The optical coupling structure 14′ of the instant disclosure does not include the inclined reflective surface 145 as shown in FIG. 1A. In addition, the first reflective surface 142a and the second reflective surface 142b have different slopes. That is, the second acute angle θ2 formed between the second reflective surface 142b and the optical axis of the collimating lens 141a is larger than the first acute angle θ1 formed between the first reflective surface 142a and the optical axis of the collimating lens 141a.

In the instant embodiment, the second beam L2′ reflected by the second reflective surface 142b directly projects on the second outputting portion 144 without passing through the inclined reflective surface 145. Accordingly, the optical axis of the second optical lens 144a of the second outputting portion 144 is arranged to be inclined with respect to the optical axis of the collimating lens 141a at an angle so that the second beam L2′ can be converged by the second optical lens 144a and focus on the photodetector 12.

To sum up, in the optical coupling structures and the optical communication apparatus provided in the embodiments of the instant disclosure, the light output power of the lighting element can be monitored by the photodetector. In the instant disclosure, the light splitting portion of the optical coupling structure includes two reflective surfaces having the same or different slopes, and a height difference is formed between these two reflective surfaces. The initial optical signal L outputted by the lighting element enters the optical coupling structure, projects on two different reflective surfaces of the light splitting portion to be divided into the first beam and the second beam respectively emitting toward different directions. The first beam and the second beam are respectively transmitted to the optical transmission unit and the photodetector.

As such, the light output power of the lighting element can be monitored according to the second optical signal. Once the deterioration of the lighting element or any other problems occur, the lighting element can be repaired or replaced to maintain the stability of the optical communication. In addition, the parallel beam can be divided by the light splitting portion of optical coupling structure in the instant disclosure, and an additional splitter can be omitted to reduce cost.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. An optical coupling structure comprising:
a light incident portion for receiving an initial optical signal emitted by a lighting element, wherein the initial optical signal is converted into a parallel beam by passing through the light incident portion;
a light splitting portion disposed on an optical path of the parallel beam, wherein the light splitting portion includes a first reflective surface, a second reflective surface, and a connecting surface connected between the first reflective surface and the second reflective surface so that a height difference exists between the first reflective surface and the second reflective surface, the parallel beam is reflected by the first reflective surface and the second reflective surface and divided into a first beam and a second beam, and slopes of the first reflective surface and the second reflective surface are positive or negative;
a first light emitting portion disposed on an optical path of the first beam, wherein the first beam is converted into a first optical signal for transmitting to an optical transmission unit through the first light emitting portion; and
a second light emitting portion disposed on an optical path of the second beam, wherein the second beam is converted into a second optical signal for transmitting to a photodetector through the second light emitting portion.

2. The optical coupling structure according to claim 1, wherein the light incident portion includes a collimating lens for converting the initial optical signal into the parallel beam, and the connecting surface is arranged substantially parallel to an optical axis of the collimating lens.

3. The optical coupling structure according to claim 2, wherein the first reflective surface is substantially parallel to the second reflective surface.

4. The optical coupling structure according to claim 2, further comprising a recess portion arranged opposite to the light incident portion, wherein the first reflective surface, the second reflective surface and the connecting surface are disposed on an inner wall of the recess portion.

5. The optical coupling structure according to claim 2, wherein both the first reflective surface and the second reflective surface are total-reflection surface.

6. The optical coupling structure according to claim 2, wherein the first reflective surface and the optical axis forms a first acute angle, the second reflective surface and the optical axis forms a second acute angle, and the first acute angle is smaller than the second acute angle.

7. The optical coupling structure according to claim 1, wherein the first light emitting portion includes a first optical lens for receiving the first beam, the second light emitting portion includes a second optical lens for receiving the second beam, the first optical lens converges the first beam to output the first optical signal, and the second optical lens converges the second beam to output the second optical signal.

8. The optical coupling structure according to claim 7, wherein the second beam is reflected off an inclined reflective surface disposed on an optical axis of the second optical lens and projects on the second optical lens.

9. The optical coupling structure according to claim 8, wherein the slope of the second reflective surface is positive, a slope of the inclined reflective surface is negative, and the inclined reflective surface is spaced apart from an optical path of the first beam.

10. An optical communication apparatus comprising:
a lighting element for emitting an initial light signal;
an optical transmission unit;
a photodetector, wherein the photodetector and the optical transmission unit are arranged at the same side of the lighting element; and
an optical coupling structure comprising:
a light incident portion for receiving the initial optical signal, wherein the initial optical signal is converted into a parallel beam by passing through the light incident portion;
a light splitting portion disposed on an optical path of the parallel beam, wherein the light splitting portion includes a first reflective surface, a second reflective surface, and a connecting surface connected between the first reflective surface and the second reflective surface so that a height difference exists between the first reflective surface and the second reflective surface, the parallel beam is reflected by the first reflective surface and the second reflective surface and divided into a first beam and a second beam, and slopes of the first reflective surface and the second reflective surface are both positive or both negative;
a first light emitting portion disposed on an optical path of the first beam, wherein the first beam is converted into a first optical signal for projecting to an optical transmission unit by passing through the first light emitting portion; and
a second light emitting portion disposed on an optical path of the second beam, wherein the second beam is converted into a second optical signal for projecting to a photodetector by passing through the second light emitting portion.

11. The optical communication apparatus according to claim 10, wherein the light incident portion includes a collimating lens for converting the initial optical signal into the parallel beam, and the connecting surface is arranged substantially parallel to an optical axis of the collimating lens.

12. The optical communication apparatus according to claim 11, wherein the first reflective surface is substantially parallel to the second reflective surface.

13. The optical communication apparatus according to claim 11, further comprising a recess portion arranged opposite to the light incident portion, wherein the first reflective surface, the second reflective surface and the connecting surface are disposed on an inner wall of the recess portion.

14. The optical communication apparatus according to claim 11, wherein both the first reflective surface and the second reflective surface are total-reflection surfaces.

15. The optical communication apparatus according to claim 11, wherein the first reflective surface and the optical axis forms a first acute angle, the second reflective surface and the optical axis forms a second acute angle, and the first acute angle is smaller than the second acute angle.

16. The optical communication apparatus according to claim 10, wherein the first light emitting portion includes a first optical lens for receiving the first beam, the second light emitting portion includes a second optical lens for receiving the second beam, the first optical lens converges the first beam to output the first optical signal, and the second optical lens converges the second beam to output the second optical signal.

17. The optical communication apparatus according to claim 16, wherein the second beam is reflected off an inclined reflective surface disposed on an optical axis of the second optical lens and projects on the second optical lens.

18. The optical communication apparatus according to claim 17, wherein the slope of the second reflective surface is positive, a slope of the inclined reflective surface is negative, and the inclined reflective surface is spaced apart from an optical path of the first beam.
